(19) United States
(12) Patent Application Publication
(10) Pub. No.: US 2010/0126941 A1
(43) Pub. Date: May 27, 2010

(54) APPARATUS, SYSTEM AND METHOD FOR DISCHARGING WASTEWATER FROM A WELL-HOUSE

(76) Inventor: Craig Allan Stiles, Malta, MT (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/619,539

(22) Filed: Nov. 16, 2009

Related U.S. Application Data
(60) Provisional application No. 61/115,788, filed on Nov. 18, 2008.

(51) Int. Cl. B01D 33/327

(52) U.S. Cl. 210/747; 210/98

(57) ABSTRACT

A wastewater disposal system passively accumulates and dumps wastewater, which may advantageously prevent ice from forming in a drain line. The system includes a dump having two compartments. The dump is pivotally mounted to oscillate between a first and a second position under the influence of the weight of wastewater accumulated in the compartments. In the first position, a first compartment is aligned with an inlet while a second compartment is tilted to discharge or dump accumulated wastewater. In the second position, the second compartment is aligned with the inlet and the first compartment tilted to discharge or dump accumulated wastewater. Such may be useful at hydrocarbon well heads, particularly in cold environments.

### CROSS REFERENCE TO RELATED APPLICATIONS

This application claims benefit under 35 U.S.C. 119(e) of U.S. Provisional Patent Application Ser. No. 61/115,788, filed Nov. 18, 2008 and entitled “APPARATUS, SYSTEM AND METHOD FOR DISCHARGING WATER FROM A WELL-HOUSE,” which is incorporated herein by reference in its entirety.

### BACKGROUND

1. Technical Field

The present disclosure relates generally to discharging wastewater from well houses, and more particularly to a device for flushing ice crystals from gas or oil well house drain lines so as to prevent ice blockages during cold weather.

2. Description of the Related Art

Gas and oil wells typically have a well house proximal the well head for housing various mechanical and other well service equipment. Some wells produce wastewater along with the hydrocarbon stream, which wastewater needs to be separated from the production stream and then evacuated from the well house. The amount of wastewater produced varies between wells such that some wells require a substantial discharge pond. Further the evacuation of wastewater from the well house, which can be achieved using a simple drain line in warm weather, can be a serious problem during the winter in regions of the world where the temperatures drop low enough to cause the wastewater to freeze inside or at the end of the drain line sufficiently to block the exit of wastewater (plugging the drain line) causing wastewater to backup inside the well house and/or to buildup in large ice blocks adjacent the well house. While denominated as wastewater because the function of the well is to produce hydrocarbons, the wastewater may in some applications be used for some beneficial purpose or recycled.

A simple continuous flow drain line typically has insufficient volume of flow to prevent freezeup since the trickle of small quantities of wastewater allows the slow moving stream to freeze completely and buildup in layers that result in a long solid plug of ice in severe weather.

Various efforts have been attempted to solve the problem of ice buildup in the drain line by allowing a larger quantity of wastewater to collect (e.g., using a toilet like tank and flapper assembly) inside the well house and then release that quantity of wastewater all at once so as to use the head pressure of the reservoir to flush the lines much like a conventional flush toilet. Disadvantageously, while this method works in respect of flushing the lines once operated, there is a need for human or other deliberate intervention to operate the flapper once the reservoir fills. If the well house is left unattended (as often happens in remote northern locations) then the flapper tends to float up a little once the tank fills such that the wastewater trickles out past the flapper in much the same manner as any continuous drain.

There is of course the option of using level sensor devices and electronic or electro-mechanical means to periodically operate the flapper handle as often as required, but these automated systems tend to be relatively complex, expensive to install, and require maintenance due to the often caustic nature of the wastewater that is discharged from the wastewater emitter in a typical well house.

It is therefore desirable to identify a simple, reliable, inexpensive, and low maintenance means to periodically discharge wastewater from a gas or oil well house in sufficient volume to flush the drain line of ice crystals and prevent blockage.

### BRIEF SUMMARY

As described in detail herein, an apparatus collects wastewater streams, the low volume flow from which streams by itself may be insufficient to maintain the drain lines free of ice in cold weather, in a two compartment dump that gravitationally tips over about a pivot point positioned to allow tipping to occur each time the wastewater level therein shifts the dump's center of gravity off balance. Once tipped the dump's open topped design allows one dump compartment to completely empty while the second dump compartment substantially fills with wastewater until the wastewater level therein again shifts the center of gravity of the dump off balance causing the dump to tip back in the opposite direction. Advantageously, this tipping repeats, continuously alternating the dumping action between opposing dump compartments—all without human intervention.

As described in detail herein, a system includes the above apparatus mounted as high as practical inside the well house in order take maximum advantage of the head pressure available from the wastewater dumped into the chamber—thereby increasing the flushing pressure available to clear ice crystals from the drain line through which the wastewater is released from the well shack to the outside, for example into a discharge wastewater collection/retention/evaporation pond. The double-sloped design of the bottom of the tub chamber further facilitates flushing by tending to induce a swirling action in the wastewater as it exits the apparatus into the drain lines of the well house.

A wastewater disposal apparatus, for use in a well house accumulating wastewater from a hydrocarbon well head wastewater emitter and then using said wastewater to flush drain lines and prevent ice blockage, may be summarized as comprising: an inlet fluidly coupled to said wastewater emitter; a dump having two compartments alternately accumulating wastewater in a cycle from said inlet, the dump further having a pivot point, the first of said compartments accumulating wastewater until the dump's center of gravity shifts causing the dump to be off balance and tip in a first direction about said pivot point thereby dumping said accumulated wastewater, whereupon the second of said compartments accumulates wastewater until the dump's center of gravity shifts causing the dump to be off balance and tip in a second direction about said pivot point thereby dumping said accumulated wastewater and permitting said dump compartments to repeat said cycle; a chamber pivotally coupled to said dump, for collecting said dumped accumulated wastewater; and an outlet fluidly coupling said chamber to a drain line, for disposing of said wastewater outside said well house.

It is to be understood that the inlet, dump, chamber, and outlet need not be mechanically coupled to one another so long as they are operationally coupled—and means for permitting the dump to pivot are provided according to the resulting alternate embodiment of the apparatus.

An apparatus may be summarized as comprising: an inlet for receiving a trickle of wastewater from a hydrocarbon well house wastewater emitter; a tub chamber, fluidly coupled to said inlet, for directing wastewater to a drain; a double-sided dump subassembly pivotally coupled at an offset point to the interior of said tub chamber, said dump subassembly having a first and second side compartment, for collecting said wastewater alternately in said first and second side compartments, said dump subassembly pivoting about a pivot point each time said first side compartment substantially fills with wastewater whereupon wastewater dumps from said first side compartment into said tub chamber, further whereupon wastewater is collected in said second side compartment until said second side compartment substantially fills with wastewater whereupon wastewater dumps from said second side compartment into said chamber; and an outlet fluidly coupled to said tub chamber for evacuating dumped wastewater to a drain.

A wastewater disposal system, for use with a well house accumulating wastewater discharged from a hydrocarbon well head wastewater emitter and then using said wastewater to flush drain lines and prevent ice blockage, may be summarized as comprising: discharge reception means, for transferring a trickle of dripping wastewater from a hydrocarbon well house wastewater emitter to a wastewater accumulation and flushing apparatus; a wastewater accumulation and flushing apparatus operationally coupled to said discharge reception means, the apparatus having an outlet through which to rapidly flush said accumulated wastewater; and a drain line fluidly coupled to said outlet, for disposing of said wastewater from said well house.

A method for disposing of a trickle of wastewater from a hydrocarbon well house, may be summarized as comprising: receiving dripping wastewater from a hydrocarbon well-head wastewater-emitter; accumulating said dripping wastewater to form a body of wastewater sufficient in volume to flush drain lines and prevent ice blockage, said accumulation to take place in a pivoting double-sided dump at a location where the formation of said body of wastewater shifts the balance of said pivoting dump; and permitting said shift of balance to cause the dumping of a first side of said double-sided dump simultaneously initiating the accumulation of said dripping wastewater in a second side of said double-sided dump so as to initiate a cycle alternately dumping each said body of wastewater.

A wastewater disposal system may be summarized as comprising: an inlet configured to fluidly couple to a source of wastewater; a dump pivotally coupled to oscillate back and forth about a pivot axis between a first position and a second position, the dump having two compartments that are open at a respective top of the compartments, the compartments each having a respective interior to accumulate wastewater therein, a shape of the interiors such that a respective centroid of the interiors is each laterally offset from the pivot axis, and where in the first position the first one of the compartment is in a substantially upright position with the open top of the first one of the compartments aligned with the inlet to accumulate wastewater from the inlet into the interior of the first one of the compartments and the second one of the compartments is in a tilted position with at least a portion of the open top of the second one of the compartments spaced at or below the pivot axis to dump at least some wastewater accumulated in the second one of the compartments and in the second position the first one of the compartments is in a tilted position with at least a portion of the open top of the first one of the compartments spaced at or below the pivot axis to dump at least some wastewater accumulated in the first one of the compartments and the second one of the compartments is in a substantially upright position with the open top of the second one of the compartments aligned with the inlet to accumulate wastewater from the inlet into the interior of the second one of the compartments, and where the dump is passively driven by the accumulation of wastewater in and the dumping of wastewater from the first and the second ones of the compartments; a chamber positioned with respect to the dump to collect the accumulated wastewater dumped from each of the first and the second compartments; and an outlet configured to fluidly couple the chamber to a drain line. The wastewater disposal system may further comprise a discharge reception coupled to transfer a trickle of dripping wastewater from a hydrocarbon well house wastewater emitter to the inlet; and the drain line positioned to carry the collected wastewater from a well house. The shape of the interior of the second one of the compartments of the dump is the same as the shape of the interior of the first one of the compartments. The shape of the interiors of the first and the second ones of the compartments are each pyramidal, with an apex at a bottom and a base at the top of the first and the second ones of the compartments. The centroid of the interior of the second one of the compartments is spaced equally from the pivot axis as the centroid of the interior of the first one of the compartments. The wastewater disposal system may further comprise a cover selectively positionable to open and close the chamber. The inlet may be an integral part of the cover. The chamber may include at least one down sloping floor. The outlet may be an integral part of the chamber and the down sloping floor communicates with the outlet.

A wastewater disposal system to dispose of wastewater from a hydrocarbon well head may be summarized as including a chamber having an interior, a top, a bottom, and an outlet at least proximate the bottom of the chamber, the outlet configured to fluidly couple the interior of the chamber to a drain line; a dump having an interior, a top that is open and a bottom, the dump received in the interior of the chamber and pivotally coupled to oscillate back and forth in the interior of the chamber about a horizontal pivot axis when in use, a shape of the interior of the dump having a centroid that is radially offset from the pivot axis toward the top of the dump; and an inlet positioned relatively above the top of the dump and configured to fluidly couple a source of wastewater from an exterior of the chamber to the interior of the dump, where in a first position the dump is substantially upright in the interior of the chamber with the top of the dump aligned with the inlet to accumulate wastewater from the inlet in the interior of the dump with the top of the dump spaced relatively above the pivot axis, and in a second position the dump is substantially tilted in the interior of the chamber with at least a portion of the top of the dump spaced relatively at or below the pivot axis to dump at least some wastewater accumulated in the interior of the dump into the interior of the chamber, the dump passively pivoted by the accumulation of wastewater in and the dumping of wastewater from the interior of the dump.

The wastewater disposal system may further include a discharge reception coupled to transfer a trickle of dripping wastewater from a hydrocarbon well house wastewater emitter to the inlet; and the drain line positioned to carry the collected wastewater from a well house. The interior of the dump may have a parabolic shaped cross-section, the apex of the parabolic shaped cross-section being a bottom of the dump.

The wastewater disposal system wherein the chamber is open at the top may further include a cover selectively positionable to open and close the top of the chamber. The inlet may be an integral part of the cover. The dump may be pivotally coupled to the cover. The dump may be pivotally coupled to the chamber. The chamber may include at least one floor that slopes relatively downward with respect to the top of the chamber. The downward sloping floor may slope toward the outlet of the chamber.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a perspective view of a wastewater disposal system according to one embodiment of an apparatus according to one illustrated embodiment showing a tub chamber with a lid engaged and closed.

FIG. 2 is a cross-sectional view of the apparatus of FIG. 1, showing a double dump subassembly internal to the tub chamber.

FIG. 3 is a cross-sectional view of the wastewater disposal system installed in a gas well house, attached to a wastewater emitter assembly, and draining wastewater into a discharge pond, according to one illustrated embodiment.

FIG. 4 is a perspective view of a wastewater disposal system according to another illustrated embodiment, showing the dump sub-assembly inside the tub chamber.

FIG. 5 is an isometric view of a wastewater disposal system according to yet another illustrated embodiment, showing a chamber having an outlet proximate a bottom thereof and a cover having an inlet proximate a top thereof.

FIG. 6 is an exploded view of the wastewater disposal system of FIG. 5, showing a dump pivotally coupled within an interior of the chamber.

FIG. 7 is a cross-sectional view of the wastewater disposal system of FIG. 5, showing a parabolic cross-section of the dump and sloped floor of the chamber.

FIG. 8 is a right side elevational view of the wastewater disposal system of FIG. 5, showing the floor of the chamber sloping downward from a rear toward a front of the chamber.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with dump assemblies have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

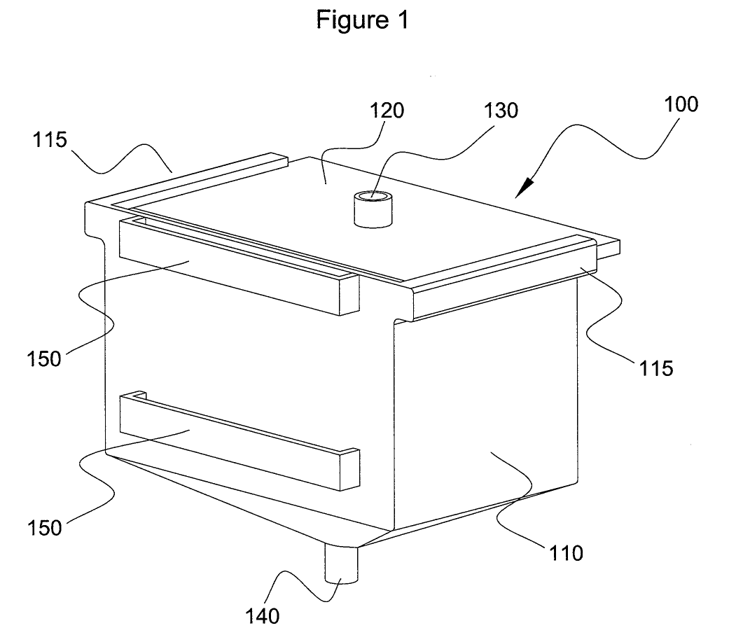

Referring to FIG. 1 there is illustrated one embodiment of a wastewater collection apparatus denoted generally as 100, wherein tub chamber 110 has a recessed upper edge 115 into which top 120 slidingly engages to form the upper boundary of the space within tub chamber 110. The top 120 is selectively removable. Positioned proximal the center (lengthwise) and middle (widthwise) of top 120 there is an inlet 130 being any suitable structure to allow connection to a discharge line (not shown in FIG. 1) from a typical hydrocarbon well house wastewater emitter or source (not shown). Inlet 130 includes an opening the purpose of which is to guide a stream of wastewater into the space within tub chamber 110. Similarly positioned proximal the center and middle of the bottom of tub chamber 110 there is provided outlet 140 being any suitable structure to allow connection to a typical drain line (not shown in FIG. 1) through which wastewater is evacuated from a well house. On an exterior face of tub chamber 110 there are provided any suitable mounting structure, for example mounting brackets 150, to permit apparatus 100 to be securely fastened (typically to the interior wall of a well house) so as to support the weight of the apparatus and wastewater that it collects or accumulates between dumping cycles.

According to one embodiment of apparatus 100, most of the wastewater collection apparatus 100 is made from any suitable molded plastic, graphite or similar lightweight material that is corrosion resistant, durable, and water-proof, in a thickness sufficiently strong to carry the load of wastewater for which it is designed, but light enough in weight so as to be operationally compatible with the weight of the volume of wastewater collected or accumulated by the design. It is to be understood that the dimensions of apparatus 100 will be determined by the capacity required for the installation at which the apparatus 100 is applied. In cases where the well produces large volumes of wastewater, a higher capacity unit may be installed, however it is contemplated that an apparatus 100 capable of dumping a few gallons per cycle will be appropriate for most installations.

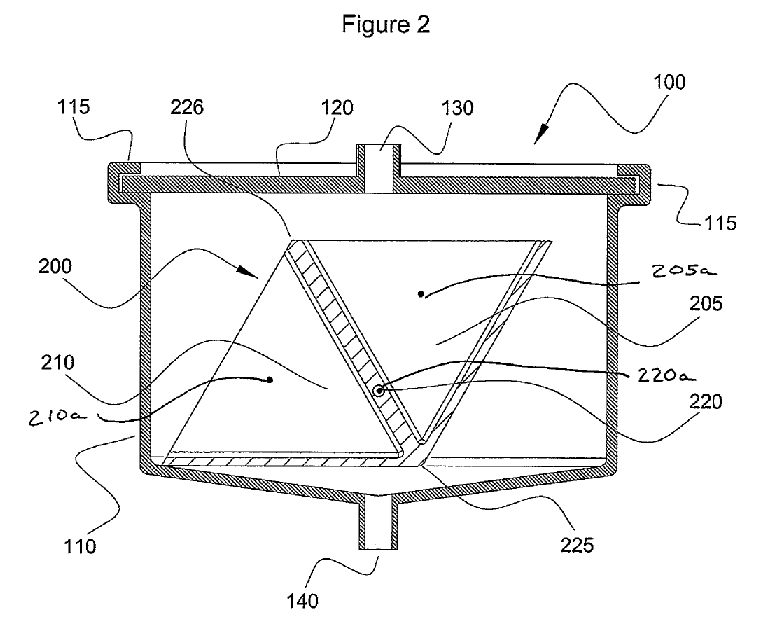

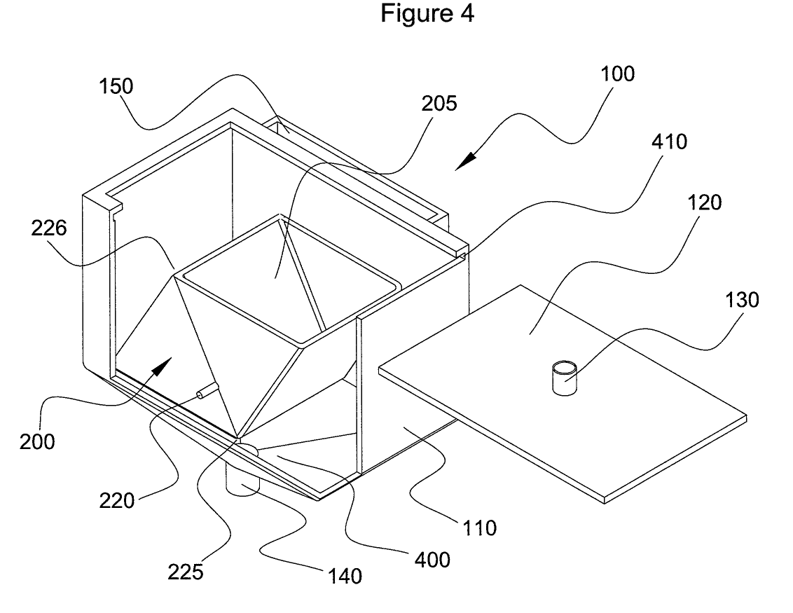

Referring to FIGS. 2 and 4 the interior components of apparatus 100 are illustrated showing dump 200 that comprises two compartments 205 and 210 to alternately collect or accumulate wastewater dripping into tub chamber 110 through inlet 130. The sub-assembly dump 200 includes pivot pin 220 that is secured to the interior of tub chamber 110 by any suitable structure that permits dump 200 to pivot about a pivot axis defined by the pin 220. According to a preferred embodiment of apparatus 100 pin 220 slidingly engages a slot (not shown) molded into the interior side walls of tub chamber 110—so as to be easily removable for de-scaling and cleaning—but still maintain the position of dump 200 substantially aligned with the center (lengthwise) and middle (laterally) of inlet 130 and at a height above outlet 140 that permits dump 200 to tip in either direction (i.e., towards either end of tub chamber 110), oscillating back and forth between a first and a second position, without interference from any portion of the interior of tub chamber 110 or from the wastewater swirling through outlet 140 during each dump cycle. In the first position, the first one of the compartments 205 is in a substantially upright position with the open top of the first one of the compartments 205 aligned with the inlet 130 to accumulate wastewater from the inlet 130 into the interior of the first one of the compartments 205 and the second one of the compartments 210 is in a tilted position with at least a portion of the open top of the second one of the compartments 210 spaced at or below the pin 220 and its associated pivot axis to dump at least some wastewater accumulated in the second one of the compartments 210. In the second position the first one of the compartments 205 is in a tilted position with at least a portion of the open top of the first one of the compartments 205 spaced at or below the pin 220 and its associated pivot axis to dump at least some wastewater accumulated in the first one of the compartments 205 and the second one of the compartments 210 is in a substantially upright position with the open top of the second one of the compartments 210 aligned with the inlet 130 to accumulate wastewater from the inlet 130 into the interior of the second one of the compartments 210. Thus, the dump 200 is passively driven by the accumulation of wastewater in and the dumping of wastewater from the first and the second ones of the compartments 205, 210.

The position of pivot pin 220 is generally approximately ¼ of the distance between a bottom 225 and a top 226 of the dump 200, however the determination of the optimal location of pin 220 is based on the dimensional and weight parameters of apparatus 100, which parameters are in turn determined by the wastewater capacity required and the density and mass of materials used in a given installation. In the illustration of FIG. 2 it may be seen that pin 220 is substantially aligned (lengthwise) with a centerline of inlet 130. As illustrated in FIG. 2, the open top of the compartment 205 is aligned with the inlet 130 so as to permit wastewater to drip (or otherwise flow) into compartment 205 during the current cycle. As the wastewater level inside compartment 205 rises it gradually shifts the center of gravity of dump 200 away from (in this example to the right of) the center line shared by pin 220 and inlet 130.

The wastewater dripping into compartment 205 eventually reaches a level that, by shifting the balance of total mass to the opposite side, induces the tipping of dump 200 (in this example to the right) such that at least a portion of the open top of the compartment 205 is at or below the level of the pin 220, consequently dumping of the wastewater from compartment 205 into the interior of tub chamber 110. Since the top opening of compartment 205 is wider (in this embodiment a V-shaped profile or pyramidal shape) at top (i.e., base of pyramid) 226 than at bottom (i.e., apex of pyramid))225—the volume and hence mass of wastewater at the top of compartment 205 is substantially more than at its bottom, the largest portion of which body of wastewater is thus both higher above and on the opposite side of the pin 220 and its associated pivot axis to the placement of wastewater that induced the previous dump cycle. The wastewater level at which tipping occurs is partly defined by the weight of the counter-balancing empty compartment 210—together with that of the portion of the material (from which dump 200 is constructed) to the opposing (in this example left) side of the pivot point at which pin 220 is located, as well as the weight of that portion of the wastewater in compartment 205 that is then on the opposite (here left) side of pivot pin 220. In order to tip based on imbalance, the weight of the accumulated wastewater (and material used in the manufacture of that part of dump 200) on the dumpward side of dump 200 basically needs to exceed the combined weight of the smaller body of wastewater and all of the material used in the manufacture of the portion of dump 200 on the opposite side.

The principle of operation of dump 200 may be understood by considering a first class lever in which the pin 220 is the fulcrum and the body of dump 200 operates as the lever. The point where one applies force is called the effort and the effect of applying such force is called the load. With the offset position of pin 220, as an empty dump 200 tips to either side—the majority of the empty body (and hence its mass—in this example=the load) is positioned on that side to which dump 200 was tipped. Once so tipped, an empty dump 200 will tend to remain in that position resting on the bottom of tub chamber 110 (so to tip this load back—force is applied to the opposite side). And, the smaller portion of the mass of the empty body of dump 200 will then be positioned on the opposite side of pin 220 and its associated pivot axis with (as may be seen in FIG. 2) the open top to compartment 205 (i.e., the effort since it is here where the incrementally increasing force of the weight of wastewater dripping into compartment 205 is applied) facing upward and exposed to inlet 130. Advantageously, the offset positioning of pin 220 and the wide opening to compartments 205 and 210 ensures that only the compartment away from the tipped side is exposed to inlet 130 (i.e., alternating aligning the open top of each compartment with the inlet 130), such that when wastewater enters apparatus 100, only one compartment at a time is positioned to collect wastewater. In the present example shown in FIG. 2 as wastewater accumulates in compartment 205 the combined mass to the right side of pin 220 and the pivot axis increases as the wastewater level rises. Eventually the weight of the wastewater (generally heavier per unit volume than the materials from which dump 200 is constructed) in compartment 205 exceeds the weight of the empty compartment 210 even when combined with both—the extra material (typically plastic) between pin 220 and vertex 226—and the wastewater located inside compartment 205, but to the left of pin 220. Once the combined mass to the right of pin 220 exceeds that to the left of pin 220, the center of gravity of dump 200 having shifted across the point of balance, dump 200 tips to the right and the wastewater accumulated in compartment 205 spills into tub chamber 110 from which it may drain via outlet 140.

It will be understood by a person of skill in the art of mechanical designs that the density and weight of the (typically molded plastic) material used to construct dump 200 should be such that it is light enough to permit the weight of the volume of wastewater collected in compartment 205 to be enough to shift the combined center of gravity sufficiently to initiate the dumping action without human or other intervention. If the material from which dump 200 is constructed is so heavy that the combined (i.e., of the dump plus one compartment full of wastewater) center of gravity remains either on or (in this example) to the left of the centerline between 130 and 220, then dump 200 will not tip without assistance.

If pin 220 is positioned too low (i.e., too close to bottom 225), then it will tend to dump prematurely thereby inefficiently not taking advantage of the capacity of compartment 205 and likely not collecting sufficient wastewater to generate the flushing action used to clear the drain line of ice. And, if pin 220 is positioned too high (i.e., too close to top 226) then dump 200 will not tip without help. Preferably, the position of pin 220 along the line between base 225 and vertex 226 is such that compartment 205 (or alternately compartment 210) is substantially full of wastewater at the time of dumping—to take best advantage of the flushing effect. In an embodiment where the distance between bottom 225 and top 226 was 12 inches a pin position of approx 3 inches between pin 220 and bottom 225 provided an apparatus 100 that functioned well and reliably.

Advantageously, for a given material selection to construct dump 200, once the location of pivot pin 220 is optimally defined—the apparatus operates reliably passively without human intervention or without a dedicated motor or drive system, and requires minimal maintenance. While there is a range of positions (between bottom 225 and top 226) for mounting (fulcrum) pivot pin 220 in which dump 200 is operable, according to a preferred embodiment of apparatus 100 it is desirable to position pin 220 such that, for the particular capacity (i.e., dumper dimensions) or the unit and the density of the material from which dump 200 is manufactured, the assembly's center of gravity does not shift until the compartment (in this example 205) accumulating the wastewater is substantially full. Advantageously, selecting or adjusting the position of pin 220 so as to trigger dumping when the compartments are full tends to provide the greatest flushing effect. Notably, each compartment 205, 210 has an interior, the shape of which has a centroid 205a, 210a, respectively. The centroids 205a, 210a are laterally spaced from the pin 220 and its associated pivot axis 220a. The centroids 205a, 210a, are preferably equally positioned or spaced from the pin 220 or pivot axis 220a, although such is not absolutely necessary for operation of the apparatus 100. The compartments 205, 210 preferably have identical or near identical shapes, although an apparatus with compartments 205, 210 whose shapes are not identical is possible. While compartments 205, 210 are illustrated as being pyramidal, other shapes are possible. Further, while illustrated as having a square or rectangular open top, the open tops of the compartments 205, 210 may have other shapes.

It is to be understood that the shape of dump 200 is conveniently selected to be a simple double V profile, but that other shapes that similarly permit the reliable passive shifting of the point of balance without human or automated intervention could be incorporate into alternate designs without materially changing the principles of its operation.

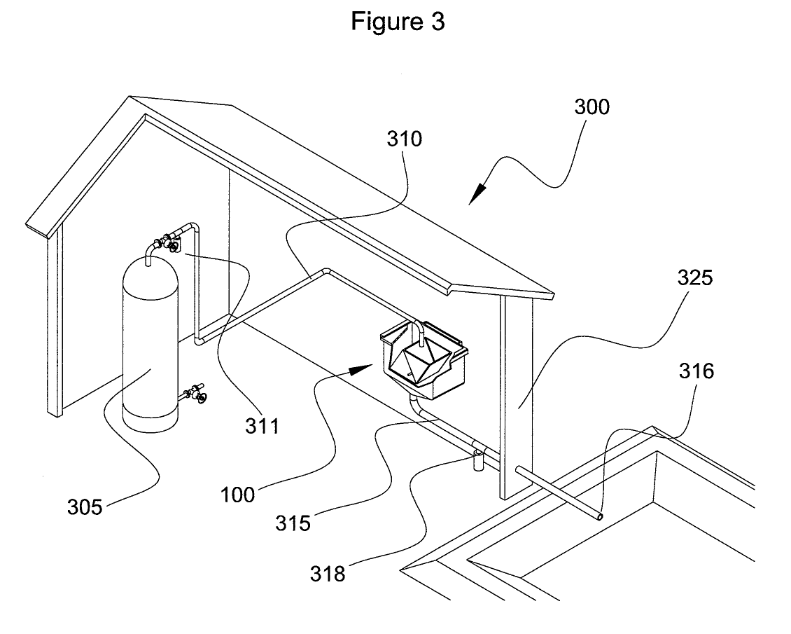

Referring to FIG. 3 there is illustrated a preferred embodiment of a wastewater collection and discharge system denoted generally as 300, wherein apparatus 100 is installed in series with a wastewater emitter discharge line 310 and well house drain line 315. At a hydrocarbon well house where any conventional wastewater separation and emission device 305 pushes or supplies wastewater into a discharge line 310, any suitable isolation valve 311 may be used in combination with a small discharge pump to facilitate moving the wastewater upwards to a higher elevation inside the well house so as to take advantage of any additional head pressure that may be available to flush ice from drain line 315. Discharge line 310, whether under pressure or not, delivers wastewater (whether as a series of drips or continuous stream) to apparatus 100 which operates taking advantage of a shifting center of gravity such that the point of balance alternates between the two compartments 205, 210 of dump 200 which releases substantial quantities of swirling wastewater into drain line 315 so as to resist any tendency for drain line 315 to freeze up outside well house wall 325 or to block drain exit 316. Any suitable bypass valve 318 may be installed in drain line 315 to permit operators to divert wastewater to an alternate disposal means should circumstances require it.

Referring back to FIG. 4, bottom or floor 400 of tub chamber 110 may be sloped downwardly, both end to end and side to side, to facilitate inducing a swirling motion in the wastewater directed through outlet 140. The outlet may be integral to the tub chamber 100 and communicate with the bottom or floor 400. Further illustrated is an alternate embodiment of tub chamber 110 according to which recessed upper edge 410 permits top 120 to slidingly engage lengthwise to form the upper boundary of the space within tub chamber 110.

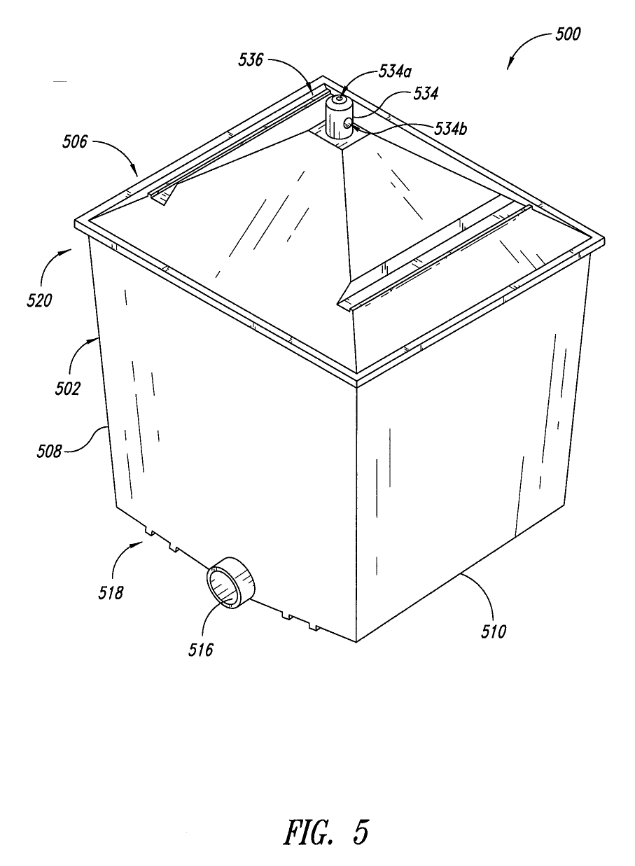

FIGS. 5-8 show a wastewater disposal system 500 according to yet another illustrated embodiment.

The wastewater disposal system 500 includes a chamber 502, a dump 504, and optionally a cover 506.

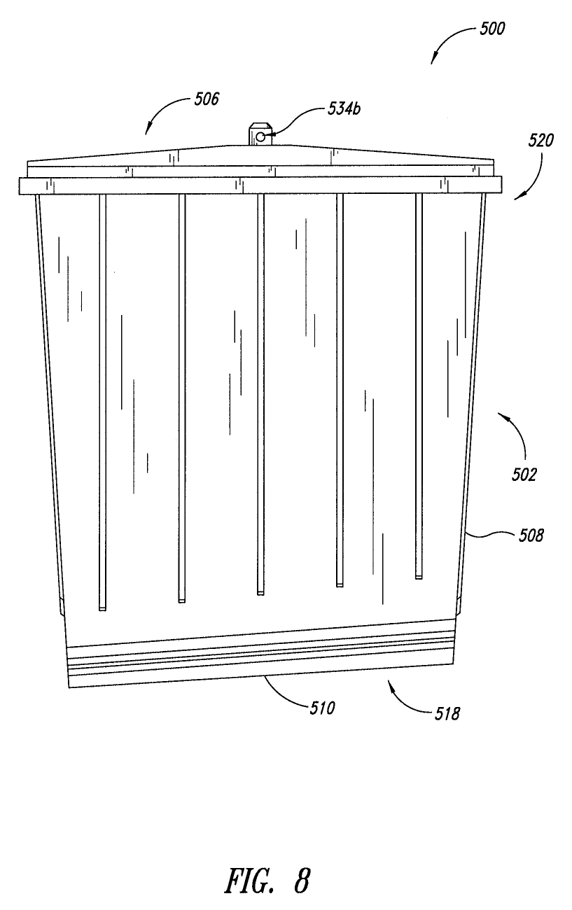

The chamber 502 is formed one or more walls 508 and a floor 510 which separate an interior 512 of the chamber 502 from an exterior 514 thereof. The chamber 502 may an outlet 516 at least proximate a bottom 518 thereof, which may be integral with the floor 510. As best illustrated in FIG. 8, the floor 510 may slope relatively downward with respect to a top 520 of the chamber 502. In particular, the floor 510 may be sloped downwardly toward the outlet 516, for example from a rear of the chamber 502 toward a front of the chamber 502 where the outlet 516 is positioned proximate the front of the chamber 502. The outlet 516 may be configured to couple to a drain line (FIG. 3) positioned to carry the collected wastewater from a well house (FIG. 3). The chamber 502 may optionally be open proximate the top 520 thereof.

The dump 504 is received in the interior 512 of the chamber 502. The dump 504 is formed of at least one wall 522 that separates an interior 524 of the dump 504 form an exterior thereof. The dump 504 has a top 526, which is open, and a bottom 528 which is closed. The dump 504 is pivotally coupled to oscillate back and forth in the interior 512 of the chamber 502 about a pivot axis 530 which is generally horizontal with reference to the ground or gravitational force when the wastewater dump system 500 is in use. The dump 504 may be pivotally coupled directly to the cover 506. Alternatively, the dump 504 may be pivotally coupled directly to the chamber 502.

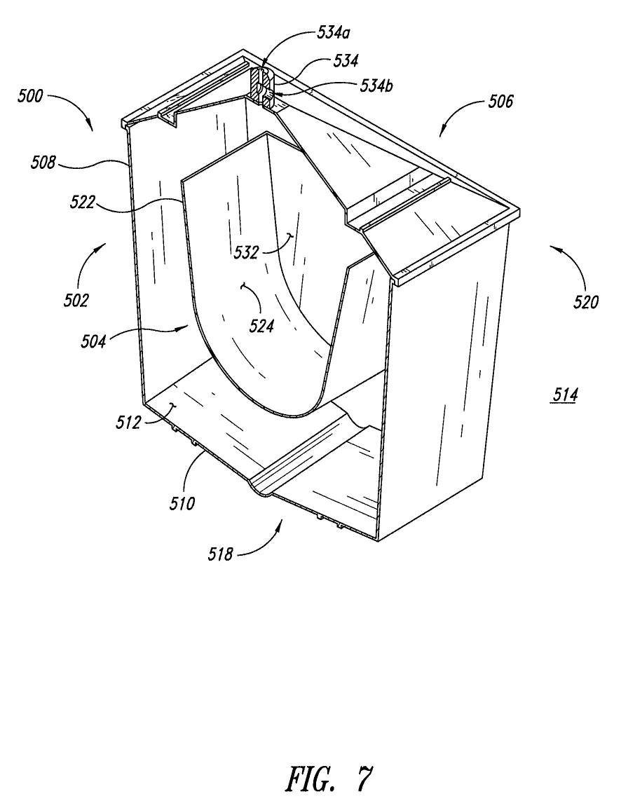

A shape of the interior 524 of the dump 504 has a centroid (illustrated by cross) 532 that is radially offset from the pivot axis 530, toward the top 526 of the dump 504. In particular, the interior of the dump 504 may have a parabolic shaped cross-section (best illustrated in FIG. 7, an apex of the parabolic shaped cross-section being a bottom 528 of the dump 504.

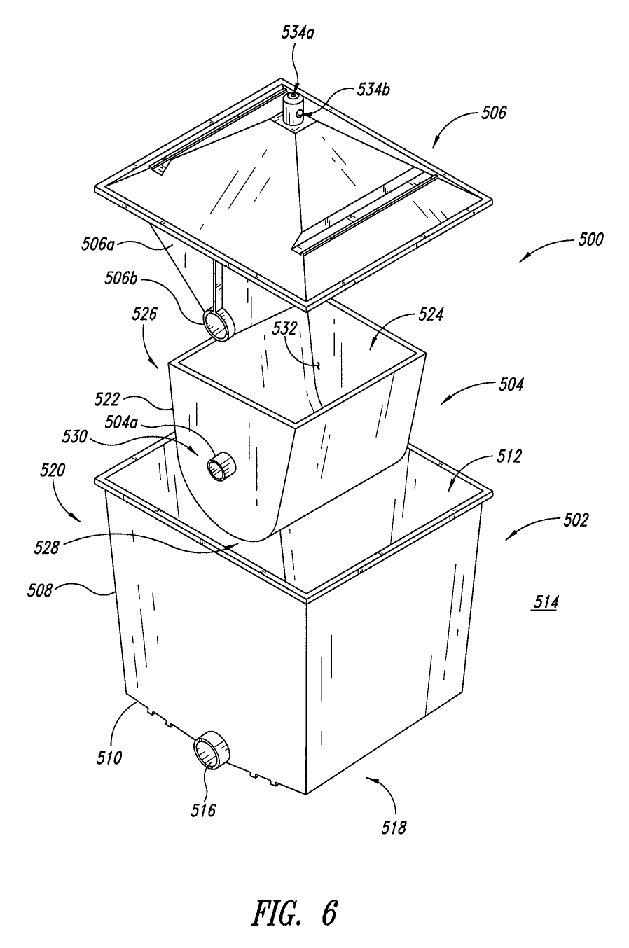

The cover 506 may be selectively positionable to open and close the top 520 of the chamber 502. The cover 506 may have an inlet 534 formed therein, for example proximate a top 536 of the cover 506. The inlet 534 may be an integral part of the cover 506. The inlet 534 may be configured to couple to a discharge reception (FIG. 3) to transfer a trickle of dripping wastewater from a hydrocarbon well house wastewater emitter (FIG. 3) to the inlet 534. The inlet 534 may have a first opening 534a that provides a fluid path or fluid communication to the discharge reception. The inlet 534 may optionally have a second opening 534b that provides a fluid path or fluid communications with the atmosphere to equalize pressure and facilitate the flow of wastewater. The cover 506 may include a pair of opposed brackets 506a (only one visible in FIG. 6), which extend respectively downwardly from the cover 506 and which are received in the interior 512 of the chamber 502 when in use. The brackets 506a may include journals or similar structures 506b that rotationally receive respective ones of opposed bearings 504a (only one visible in FIG. 6) of the dump 504 to pivotally couple the dump 504 within the interior 512 of the chamber 502.

In operation, the dump 504 oscillates or pivots back and forth in the interior 512 of the chamber 502 as wastewater alternatingly accumulates and is dumped from the interior 524 of the dump 504. In a first position, the dump 504 is substantially upright (illustrated in FIG. 7) in the interior 512 of the chamber 502 with the top 526 of the dump 504 aligned with the inlet 534 to accumulate wastewater from the inlet 534 in the interior 524 of the dump 504 with the top 526 of the dump 504 spaced relatively above the pivot axis 530. In a second position, the dump 504 is substantially tilted in the interior 512 of the chamber 502 with at least a portion of the top 526 of the dump 504 spaced relatively at or below the pivot axis 530 to dump at least some wastewater accumulated in the interior 524 of the dump 504 into the interior 512 of the chamber 502. As wastewater accumulates in the interior 524 of the dump 504, the accumulated wastewater conforms to the shape of the interior 524. Thus, the wastewater has a centroid that is radially spaced relatively above the pivot axis 530. Consequently, the dump 504 with the accumulated wastewater becomes top heavy, and is passively pivoted by the accumulation of wastewater in the interior 524 of the dump 504, subsequently dumping of wastewater from the interior 524 of the dump 504 as the weight of the accumulated waste water causes the dump 504 to tip or tilt.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. A wastewater disposal apparatus, for use in a well house accumulating wastewater from a hydrocarbon well head wastewater emitter and then using said wastewater to flush drain lines and prevent ice blockage, the wastewater disposal apparatus comprising:
an inlet configured to be fluidly coupled to said wastewater emitter;
a dump having two compartments to alternately accumulate wastewater in a cycle from said inlet, the dump further having a pivot point, the first of said compartments accumulating wastewater until a center of gravity of the dump and the accumulated wastewater shifts causing the dump to be off balance and tip in a first direction about said pivot point thereby dumping said accumulated wastewater, whereupon the second of said compartments accumulates wastewater until the center of gravity shifts causing the dump to be off balance and tip in a second direction about said pivot point thereby dumping said accumulated wastewater and permitting said dump compartments to repeat said cycle;
a chamber pivotally coupled to said dump, for collecting said dumped accumulated wastewater; and
an outlet configured to fluidly couple said chamber to a drain line, for disposing of said wastewater outside said well house.

2. A wastewater disposal system, comprising:
an inlet configured to fluidly couple to a source of wastewater;
a dump pivotally coupled to oscillate back and forth about a pivot axis between a first position and a second position, the dump having two compartments that are open at a respective top of the compartments, the compartments each having a respective interior to accumulate wastewater therein, a shape of the interiors such that a respective centroid of the interiors is each laterally offset from the pivot axis, and where in the first position the first one of the compartment is in a substantially upright position with the open top of the first one of the compartments aligned with the inlet to accumulate wastewater from the inlet into the interior of the first one of the compartments and the second one of the compartments is in a tilted position with at least a portion of the open top of the second one of the compartments spaced at or below the pivot axis to dump at least some wastewater accumulated in the second one of the compartments and in the second position the first one of the compartments is in a tilted position with at least a portion of the open top of the first one of the compartments spaced at or below the pivot axis to dump at least some wastewater accumulated in the first one of the compartments and the second one of the compartments is in a substantially upright position with the open top of the second one of the compartments aligned with the inlet to accumulate wastewater from the inlet into the interior of the second one of the compartments, and where the dump is passively driven by the accumulation of wastewater in and the dumping of wastewater from the first and the second ones of the compartments;
a chamber positioned with respect to the dump to collect the accumulated wastewater dumped from each of the first and the second compartments; and
an outlet configured to fluidly couple the chamber to a drain line.

3. The wastewater disposal system of claim 2, further comprising:
a discharge reception coupled to transfer a trickle of dripping wastewater from a hydrocarbon well house wastewater emitter to the inlet; and
the drain line positioned to carry the collected wastewater from a well house.

4. The wastewater disposal system of claim 2 wherein the shape of the interior of the second one of the compartments of the dump is the same as the shape of the interior of the first one of the compartments.

5. The wastewater disposal system of claim 2 wherein the shape of the interiors of the first and the second ones of the compartments are each pyramidal, with an apex at a bottom and a base at the top of the first and the second ones of the compartments.

6. The wastewater disposal system of claim 2 wherein the centroid of the interior of the second one of the compartments is spaced equally from the pivot axis as the centroid of the interior of the first one of the compartments.

7. The wastewater disposal system of claim 2 wherein the chamber includes at least one down sloping floor and the down sloping floor communicates with the outlet.

8. The wastewater disposal system of claim 2, further comprising:
a cover selectively positionable to open and close the chamber, and wherein the inlet is part of the cover.

9. A wastewater disposal system to dispose of wastewater from a hydrocarbon well head, comprising:
a chamber having an interior, a top, a bottom, and an outlet at least proximate the bottom of the chamber, the outlet configured to fluidly couple the interior of the chamber to a drain line;
a dump having an interior, a top that is open and a bottom, the dump received in the interior of the chamber and pivotally coupled to oscillate back and forth in the interior of the chamber about a horizontal pivot axis when in use, a shape of the interior of the dump having a centroid that is radially offset from the pivot axis toward the top of the dump; and
an inlet positioned relatively above the top of the dump and configured to fluidly couple a source of wastewater from an exterior of the chamber to the interior of the dump,
where in a first position the dump is substantially upright in the interior of the chamber with the top of the dump aligned with the inlet to accumulate wastewater from the inlet in the interior of the dump with the top of the dump spaced relatively above the pivot axis, and in a second position the dump is substantially tilted in the interior of the chamber with at least a portion of the top of the dump spaced relatively at or below the pivot axis to dump at least some wastewater accumulated in the interior of the dump into the interior of the chamber, the dump passively pivoted by the accumulation of wastewater in and the dumping of wastewater from the interior of the dump.

10. The wastewater disposal system of claim 9, further comprising:
a discharge reception coupled to transfer a trickle of dripping wastewater from a hydrocarbon well house wastewater emitter to the inlet; and
the drain line positioned to carry the collected wastewater from a well house.

11. The wastewater disposal system of claim 9 wherein the interior of the dump has a parabolic shaped cross-section, the apex of the parabolic shaped cross-section being a bottom of the dump.

12. The wastewater disposal system of claim 9 wherein the chamber is open at the top, further comprising:
a cover selectively positionable to open and close the top of the chamber.

13. The wastewater disposal system of claim 12 wherein the inlet is an integral part of the cover.

14. The wastewater disposal system of claim 12 wherein the dump is pivotally coupled to the cover.

15. The wastewater disposal system of claim 12 wherein the dump is pivotally coupled to the chamber.

16. The wastewater disposal system of claim 9 wherein the chamber includes at least one floor that slopes relatively downward with respect to the top of the chamber.

17. The wastewater disposal system of claim 16 wherein the downward sloping floor slopes toward the outlet of the chamber.

18. A method for disposing of a trickle of wastewater from a hydrocarbon well house, the method comprising:
receiving dripping wastewater from a hydrocarbon well-head wastewater-emitter;
accumulating said received dripping wastewater to form a body of wastewater sufficient in volume to flush drain lines and prevent ice blockage, said accumulation to take place in a pivoting double-sided dump at a location where the formation of said body of wastewater shifts a balance of said pivoting dump; and
permitting said shift of balance to cause the dumping of a first side of said double-sided dump simultaneously initiating the accumulation of said dripping wastewater in a second side of said double-sided dump so as to initiate a cycle alternately dumping each said body of wastewater.

19. The method of claim 18 wherein the accumulating and the dumping are passively accomplished without the use of a dedicated motor or drive system.
